(19) United States
(12) Patent Application Publication
(10) Pub. No.: US 2025/0065295 A1
(43) Pub. Date: Feb. 27, 2025

(54) THREE-DIMENSIONAL LITHIUM ADSORBENT AND METHOD FOR PREPARING THE SAME

(71) Applicant: Hojeonable Inc., Daejeon (KR)

(72) Inventors: Jong Tae MOON, Gyeryong-si (KR); Beyoung-Hwan RYU, Daejeon (KR); Shin CHOI, Gumi-si (KR); Nayoung KIM, Daejeon (KR)

(21) Appl. No.: 18/811,525

(22) Filed: Aug. 21, 2024

(30) Foreign Application Priority Data
Aug. 22, 2023 (KR) 10-2023-0109937

(51) Int. Cl. B01J 20/04; B01J 20/06; B01J 20/28; B01J 20/30

(52) U.S. Cl. CPC B01J 20/041; B01J 20/06; B01J 20/28016; B01J 20/3007; B01J 20/3078; B01J 2220/4806

(57) ABSTRACT

Provided are a method for preparing a three-dimensional lithium adsorbent, which produces a lithium adsorbent having a high lithium adsorption rate per unit volume and unit mass, strong durability, and various shapes, and a three-dimensional lithium adsorbent using the same.

### CROSS-REFERENCE TO RELATED APPLICATIONS

This application claims priority under 35 U.S.C. § 119 to Korean Patent Application No. 10-2023-0109937, filed on Aug. 22, 2023, in the Korean Intellectual Property Office, the disclosure of which is incorporated herein by reference in its entirety.

### TECHNICAL FIELD

The following disclosure relates to a method for preparing a three-dimensional lithium adsorbent, which produces a lithium adsorbent having a high lithium adsorption rate per unit volume and unit mass, strong durability, and various shapes, and a three-dimensional lithium adsorbent using the same.

### BACKGROUND

Since lithium and lithium compounds are being used in a wide range of fields such as secondary battery materials, refrigerant adsorbents, catalysts, and medicines, they are one of the important resources receiving attention for its high usability. In addition, a demand for lithium and lithium compounds is expected to be further increased in the technical fields such as large-capacity batteries and electric automobiles nearing commercialization.

As such, though lithium is an important rare earth resource which may be applied to various fields, the global reserves of lithium are only 2 to 9 million tons. As various methods for overcoming the limitation of the reserves, research to secure lithium resources continues.

As a part of the research, studies for effectively recovering lithium which is contained in a small amount in an aqueous solution such as seawater, brine, and lithium battery waste fluid are in the spotlight. As a conventional lithium recovery method, technology for obtaining lithium by reducing a lithium ion using an electrochemical method or using a metal such as magnesium or aluminum to reduce a lithium oxide is being developed, and furthermore, a method for recovering lithium using an adsorbent which selectively adsorb a lithium ion is also being studied.

The main interest of the study of the method for recovering lithium using a lithium adsorbent has been development of an adsorbent having high selectivity for a lithium ion; development of an adsorbent having excellent adsorption and desorption performance; and the like.

As one of the studies, a method for preparing powder capable of easy adsorption and desorption of lithium by a solid phase reaction method or gel method using a manganese oxide is known, and manganese oxide powder prepared by the method has been used as positive electrode materials for a lithium secondary battery, materials of a lithium adsorbent, and the like. However, since it is not easy to use a lithium adsorbent in a powder state in processing or handling, the lithium adsorbent needs to be used in a carried state in a carrier.

However, when the carrier is excessively included in a lithium adsorbent, there is a problem such as a decreased lithium adsorption rate of the lithium adsorbent, and thus, development of a material for adsorbing lithium having a high lithium adsorption rate and high durability is needed.

### SUMMARY

An embodiment of the present invention is directed to providing a method for preparing a three-dimensional lithium adsorbent, which produces a lithium adsorbent having a high lithium adsorption rate per unit volume and unit mass, strong durability, and various shapes, and a three-dimensional lithium adsorbent using the same.

In one general aspect, a method for preparing a three-dimensional lithium adsorbent includes: (S1) coating a surface of a lithium positive electrode active material with one or more silane compounds satisfying the following Chemical Formula 1; (S2) mixing the lithium positive electrode active material, an inorganic binder, and a polymer bead to prepare a mixture; (S3) molding the mixture into a three-dimensional structure; and (S4) firing the structure to prepare a three-dimensional lithium adsorbent:

RₐSi(OR)_{b} (Chemical Formula 1)

wherein R is an alkyl group independently selected from alkyl groups having 1 to 4 carbon atoms; a is 0, 1, or 2; and b is an integer selected from 2 to 4.

In the method for preparing a three-dimensional lithium adsorbent according to the present invention, the lithium positive electrode active material may be an oxide including lithium (Li), and one or more metals selected from nickel (Ni), cobalt (Co), manganese (Mn), iron (Fe), magnesium (Mg), titanium (Ti), aluminum (Al), and a combination thereof.

In the method for preparing a three-dimensional lithium adsorbent according to the present invention, the inorganic binder may be one or more inorganic binders selected from red clay, cement, and a combination thereof.

In the method for preparing a three-dimensional lithium adsorbent according to the present invention, the mixture of (S2) may further include a polymer binder.

In the method for preparing a three-dimensional lithium adsorbent according to the present invention, the polymer binder may be a water-based polymer binder.

In the method for preparing a three-dimensional lithium adsorbent according to the present invention, the polymer bead may be removed by thermal decomposition by the firing of (S4).

In the method for preparing a three-dimensional lithium adsorbent according to the present invention, the mixture of (S2) may include 5 to 50 parts by weight of the inorganic binder with respect to 100 parts by weight of the lithium positive electrode active material.

In the method for preparing a three-dimensional lithium adsorbent according to the present invention, the mixture of (S2) may include 5 to 50 parts by weight of the inorganic binder and 1 to 30 parts by weight of the polymer binder with respect to 100 parts by weight of the lithium positive electrode active material.

In the method for preparing a three-dimensional lithium adsorbent according to the present invention, the molding of (S3) may be carried out using a three-dimensional stage.

In another general aspect, a three-dimensional lithium adsorbent prepared by the method for preparing a three-dimensional lithium adsorbent described above is provided.

Other features and aspects will be apparent from the following detailed description, the drawings, and the claims.

### BRIEF DESCRIPTION OF THE DRAWINGS

FIG. 1 is a schematic diagram of steps of an exemplary embodiment of the present invention.

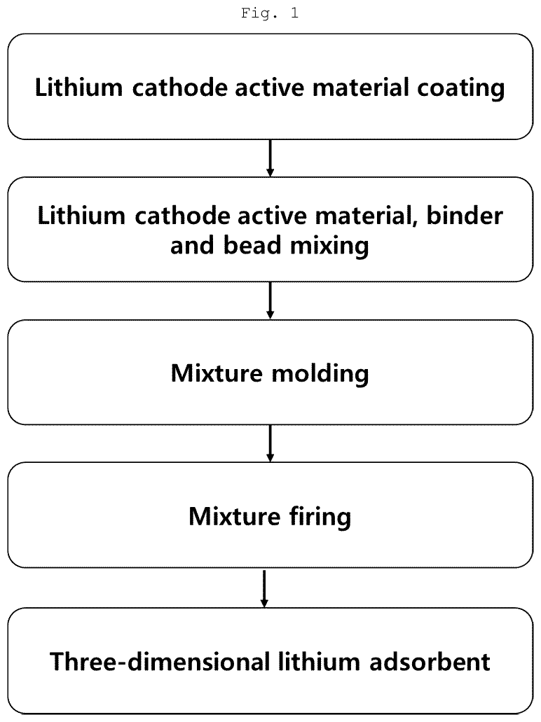

### DETAILED DESCRIPTION OF EMBODIMENTS

The embodiments described in the present specification may be modified in many different forms, and the technology according to an exemplary embodiment is not limited to the embodiments set forth herein. In addition, the embodiments of an exemplary embodiment are provided so that the present disclosure will be described in more detail to a person with ordinary skill in the art. Technical terms and scientific terms used herein have the general meaning commonly understood by a person skilled in the art to which the present invention pertains unless otherwise defined, and description for the known function and configuration which may unnecessarily obscure the gist of the present invention will be omitted in the following description and the accompanying drawings.

In addition, the singular form used in the present specification and the claims appended thereto may be intended to include a plural form also, unless otherwise indicated in the context.

In addition, in the present specification and the appended claims, the terms such as “first” and “second” are not used in a limited meaning but are used for the purpose of distinguishing one constituent element from other constituent elements.

In addition, in the present specification and the appended claims, when it is said that a part such as a film (layer), a domain, or a constituent element is positioned “on”, “in the upper portion”, “in the upper stage”, “under”, “in the lower portion”, or “in the lower stage”, it includes not only the case in which one part is in contact with the other part, but also the case in which there is another part between two parts.

In addition, the terms “about”, “substantially”, and the like used in the present specification and the appended claims are used in the meaning of the numerical value or in the meaning close to the numerical value when unique manufacture and material allowable errors are suggested in the mentioned meaning, and are used for preventing the disclosure mentioning a correct or absolute numerical value for better understanding of the present specification and the attached claims from being unfairly used by an unconscionable infringer.

In addition, the numerical range used in the present specification includes all values within the range including the lower limit and the upper limit, increments logically derived in a form and span of a defined range, all double limited values, and all possible combinations of the upper limit and the lower limit in the numerical range defined in different forms.

Furthermore, in the present specification and the appended claims, the terms such as “comprise” or “have” mean that there is a characteristic or a constituent element described in the specification, and as long as it is not particularly limited, a possibility of adding one or more other characteristics or constituent elements is not excluded in advance.

Hereinafter, the method for preparing a three-dimensional lithium adsorbent and the three-dimensional lithium adsorbent of the present invention will be described in detail.

The present invention provides a method for preparing a three-dimensional lithium adsorbent, and the method for preparing a three-dimensional lithium adsorbent includes: (S1) coating a surface of a lithium positive electrode active material with one or more silane compounds satisfying the following Chemical Formula 1; (S2) mixing the lithium positive electrode active material, an inorganic binder, and a polymer bead to prepare a mixture; (S3) molding the mixture into a three-dimensional structure; and (S4) firing the structure to prepare a three-dimensional lithium adsorbent:

RₐSi(OR)_{b} (Chemical Formula 1)

wherein R is an alkyl group independently selected from alkyl groups having 1 to 4 carbon atoms; a is 0, 1, or 2; and b is an integer selected from 2 to 4.

According to an exemplary embodiment, the lithium positive electrode active material may be an oxide including lithium (Li), and one or more metals selected from nickel (Ni), cobalt (Co), manganese (Mn), iron (Fe), magnesium (Mg), titanium (Ti), aluminum (Al), and a combination thereof. The metal oxide including lithium (Li), and one or more metals selected from nickel (Ni), cobalt (Co), manganese (Mn), iron (Fe), magnesium (Mg), titanium (Ti), aluminum (Al), and a combination thereof may form a porous body to adsorb the lithium. When the lithium is adsorbed on the porous metal oxide, the metal oxide may include lithium to form a lithium positive electrode active material. In addition, when the lithium is desorbed on the porous metal oxide, there is no or low content of lithium in the porous metal oxide. Therefore, an oxidation number of the porous metal oxide may be negative, and the oxidation number may vary depending on the chemical species of the metal contained in the porous metal oxide.

As a non-limiting example, the porous metal oxide may be one or more selected from the group consisting of nickel cobalt manganese oxide (NiMnCoO₂⁻; NCM⁻), iron phosphate oxide (FePO₄⁻; FP⁻), nickel manganese spinel oxide (Ni_{0.5}Mn_{1.5}O₄⁻; NMO⁻), nickel cobalt aluminum oxide (NiCoAlO₂⁻; NCA⁻), manganese oxide (Mn₂O₄⁻; MO⁻), cobalt oxide (CoO₂⁻; CO⁻), and a combination thereof, but the present invention is not limited thereto, and the porous metal oxide may be any one as long as it contains the metal atoms described above to have an oxidation number and structural characteristics appropriate for adsorbing lithium.

The coating of (S1) may be any method as long as it is commonly used in the art for coating a material and may uniformly coat the silane compound. According to an exemplary embodiment, the coating of (S1) may be coating using a Banbury mixer, or dip coating of the lithium positive electrode active material into the liquid silane compound and then drying, but the present invention is not limited to the coating methods.

According to an exemplary embodiment, the inorganic binder of (S2) may be one or more binders selected from red clay, cement, plaster, silica (SiO₂), and a combination thereof. The inorganic binder may serve to allow the lithium positive electrode active material to be mixed with the polymer bead well to produce a solid in (S2). Therefore, the inorganic binder may be an inorganic binder which does not chemically react with the lithium positive electrode active material and the polymer bead and are commonly used in the art. Since the inorganic binder is not removed by the firing of (S4), physical durability of the three-dimensional lithium adsorbent may be increased.

According to an exemplary embodiment, the binder may further include a polymer binder. When the lithium positive electrode active material is mixed in (S2), it may not be easily mixed depending on the physical properties of the inorganic binder. Therefore, the polymer binder is further included in addition to the inorganic binder in (S2), which may be favorable for the preparation of the mixture in (S2) and the molding in (S3).

The polymer binder may be a polymer binder which does not chemically react with the lithium positive electrode active material, the inorganic binder, and the polymer binder and is commonly used in the art. As a non-limiting example, the polymer binder may be one or more polymer binders selected from carboxymethyl cellulose, poly(acrylic acid), styrene-butadiene rubber, polyvinylidene fluoride, polyacrylonitrile, polyamide imide, hydroxypropyl methylcellulose, polyurethane, and a mixture thereof, but the present invention is not limited to the chemical species of the binder described above.

According to an exemplary embodiment, the polymer binder may be a water-based polymer binder. Since the lithium positive electrode active material may have a high solubility in water or a polar solvent, when the mixture of (S2) is prepared, the water or polar solvent may be used as the solvent. Therefore, when the polymer binder is a water-based polymer binder, it may be easy to prepare the mixture in (S2).

According to an exemplary embodiment, the polymer bead may be thermally decomposed and removed by the firing of (S4). The polymer bead may be for containing further voids in the three-dimensional lithium adsorbent. The polymer bead is mixed with the lithium positive electrode active material, the inorganic binder, and the silane compound to prepare mutually agglomerated aggregates, the polymer bead is thermally decomposed by firing or semi-firing and removed so that an empty space of the bead forms a macro void of the adsorbent, and the total voids of the three-dimensional lithium adsorbent may be provided together with the micro voids formed between the lithium positive electrode active materials.

As a non-limiting example, since the voids may be obtained by removing the beads by thermal decomposition due to the firing or semi-firing of (S4), the polymer bead may be a polymer bead including a polymer having a thermal decomposition temperature lower than the firing temperature. The polymer bead may have a thermal decomposition temperature of 150 to 500° C.

The polymer bead may have various shapes such as sphere, polygon, or hollow, and the present invention is not limited to the shape of the polymer bead. As a non-limiting example, the polymer bead may be spherical and may have a diameter of 1 μm to 3000 μm. The diameter of the bead may be 1 μm or more 5 μm or more, 10 μm or more, 50 μm or more, or 100 μm or more and, as the upper limit, 5000 μm or less, 3000 μm or less, 1000 μm or less, 500 μm or less, or 200 μm or less. Specifically, the diameter of the bead may be 1 to 5000 μm, 5 to 3000 μm, 10 to 1000 μm, 50 to 500 μm, or 100 to 200 μm. Since the sizes of voids are determined depending on the diameter of voids, the diameter of voids may be appropriately selected considering the absorption rate and the mechanical properties of the porous body within the range described above.

According to an exemplary embodiment, one or more silsesquioxane structural units prepared by condensing the silane compound are positioned in an interface between the lithium positive electrode active material and another lithium positive electrode active material adjacent thereto and the lithium positive electrode active material and another lithium positive electrode active material adjacent thereto may be connected and fixed to each other. Since the surface of the lithium positive electrode active material contains one or more silsesquioxane structural units, binding strength between the lithium positive electrode active materials may become strong, so that the mechanical properties of the three-dimensional lithium adsorbent may be increased, which is thus favorable.

The reactive functional group represented by (Or) b included in the silane compound satisfying Chemical Formula 1 may be hydrated by carrying out a pretreatment and changed into a silanol compound having a silanol (SiOH) functional group. Thereafter, the silane compound is condensed to form a three-dimensional branched network and is bonded to the surfaces of the lithium positive electrode active material and another lithium positive electrode active material adjacent thereto to connect and fix the lithium positive electrode active materials to each other. Herein, the silanol functional group may be bonded to another silicon (Si) atom in the three-dimensional branched network, of course.

According to an exemplary embodiment, the silane compound has a structure of Chemical Formula 1, and the silane compound may be hydrated and condensation-polymerized to have a structure of RSiO_{4/2}. In addition, it may further have one or more structures selected from the group consisting of RsiO_{3/2} and SiO_{4/2}. In addition, it may have another structure including the structure described above depending on whether the hydration and the condensation polymerization reaction are completed, of course.

Favorably, the silane compound is a silane compound which provides a function of a silsesquioxane-based binder by condensation polymerization, and since the silane compound satisfying Chemical Formula 1 is 70 mol % or more, 80 mol % or more, 90 mol % or more, or 100 mol % of the total silane compound, the particles of the lithium positive electrode active material are connected to each other to form an agglomerate, and even when the polymer binder and the polymer bead are removed or partially removed by firing or semi-firing of (S4), the form of the three-dimensional lithium adsorbent may be maintained as it is, which is thus favorable.

That is, as a favorable example, the silane compound may be a mixture in which the content of the silane compound wherein a is 0 is 0.8 mol or more with respect to 1 mol of the total silane compound. In Chemical Formula 1 of the silane compound, a may be 0, 1, or 2, and since there may be a mixture thereof, the silane compound wherein a is 0 may be included at 0.5 mol or more, 0.6 mol or more, 0.7 mol or more, or 0.8 mol or more and, as the upper limit, 1 mol or less with respect to 1 mol of the total silane compound. Specifically, the silane compound may include the silane compound wherein a is 0 at 0.5 to 1 mol, 0.6 to 1 mol, 0.7 to 1 mol, or 0.8 to 1 mol with respect to 1 mol of the total silane compound. The silane compound is favorable when it has the composition described above, since the mechanical durability of the porous body for adsorbing lithium may be high.

According to an exemplary embodiment, the mixture of (S2) may include 5 to 50 parts by weight of the inorganic binder with respect to 100 parts by weight of the lithium positive electrode active material. The lithium adsorption rate of the three-dimensional lithium adsorbent may vary depending on the content of the lithium positive electrode active material, but since the three-dimensional lithium adsorbent should have durability even at physical shock or pressure, the inorganic binder is mixed within the range, so that the three-dimensional lithium adsorbent may have high lithium adsorption rate while maintaining durability. The content of the inorganic binder may be appropriately selected depending on a correlation between durability and the lithium adsorption rate within the range described above.

According to an exemplary embodiment, the mixture of (S2) may include 5 to 50 parts by weight of the inorganic binder and 1 to 30 parts by weight of the polymer binder with respect to 100 parts by weight of the lithium positive electrode active material. As described above, since the mixture of (S2) may further include the polymer binder described above with the inorganic binder, the polymer binder is mixed within the range described above to improve the mixing of (S2) and the molding of (S3), and the desorption of the lithium positive electrode active material may be prevented before carrying out (S3) and (S4). In addition, the firing of (S4) is carried out, and the polymer binder may be thermally decomposed with the polymer bead and removed, of course.

According to an exemplary embodiment, the content of the bead included in the mixture of (S2) may be 1 to 50 parts by weight with respect to 100 parts by weight of the mixture of (S2), but is not necessarily limited thereto. The content of the bead included in the mixture may be 1 part by weight or more, 2 parts by weight or more, 5 parts by weight or more, or 10 parts by weight and as the upper limit, 50 parts by weight or less with respect to 100 parts by weight of the mixture. Specifically, when the bead is contained in the porous body within the range described above, the porosity of the porous body for adsorbing lithium may be appropriately adjusted, and thus, the content of the bead included in the porous body within the range may be appropriately adjusted. In addition, since the porosity may vary also depending on the size and shape of the bead, the content of the bead, the shape of the bead, and the size of the bead may be organically adjusted, of course.

According to an exemplary embodiment, the molding of (S3) may be a molding process which is commonly used in the art, such as extrusion molding, injection molding, compression molding, blow molding, foam molding, or vacuum molding. The molding may be appropriately selected depending on the physical properties of the mixture of (S2), and the present invention is not limited by the molding method.

According to an exemplary embodiment, the molding of (S3) may be carried out using a three-dimensional stage. Specifically, the three-dimensional stage may refer to a process such as 3D printing in which the mixture of (S2) is sprayed and laminated in three dimensions. Since the mixture may be prepared appropriately for use as a 3D printing ink, the mixture may be 3D printed to produce the porous body having a structure of high adsorption capacity.

The present invention provides a three-dimensional lithium adsorbent, and the three-dimensional lithium adsorbent is prepared by the method for preparing a three-dimensional lithium adsorbent described above. Since the lithium positive electrode active material, the inorganic binder, the polymer bead, and the like contained in the three-dimensional lithium adsorbent of the present invention are the same as or similar to those in the above descriptions of the method for preparing a three-dimensional lithium adsorbent, the three-dimensional lithium adsorbent includes all descriptions of the method for preparing a three-dimensional lithium adsorbent above.

According to an exemplary embodiment, the three-dimensional lithium adsorbent may be porous by including the lithium positive electrode active material and the inorganic binder but substantially not including the polymer binder and the polymer bead. As a non-limiting example, the three-dimensional lithium adsorbent may include small amounts of the binder and the porous solid foam depending on the firing temperature.

Hereinafter, the examples and the experimental examples will be illustrated specifically in detail in the following. However, the examples and the experimental examples described later are only a partial illustration, and the technology described in the present specification is not construed as being limited thereto.

### Example 1

Lithium manganese oxide (LiMn₂O₄, TOB) powder was treated with acid by soaking it in a 0.5 M hydrochloric acid (HCl) aqueous solution for 24 hours, washed with distilled water 3 times, and dried at 85° C. for 12 hours to pretreat the lithium manganese oxide powder.

150 g of the pretreated lithium manganese oxide powder, 20 g of poly(methyl methacrylate) (PMMA) beads having a diameter of 0.1 mm, 10 g of poly(vinyl alcohol) (PVA), 10 g of cement including calcium oxide (CaO), and 50 g of distilled water were mixed to prepare a mixture.

The mixture was extrusion molded into a size of a diameter of 10 mm and a major axis length of 30 mm and laminated into a 3D hierarchical structure to prepare a three-dimensional structure.

The three-dimensional structure was dried at 100° C. for 24 hours to remove moisture and was fired at 800° C. for 2 hours to prepare a three-dimensional lithium adsorbent.

### Example 2

150 g of lithium manganese oxide (LiMn₂O₄, TOB) powder, 20 g of poly(methyl methacrylate (PMMA) beads having a diameter of 0.1 mm, 10 g of poly(vinyl alcohol) (PVA), 10 g of cement including calcium oxide (CaO), and 50 g of distilled water were mixed to prepare a mixture.

The mixture was extrusion molded into a size of a diameter of 10 mm and a major axis length of 30 mm, and laminated into a 3D hierarchical structure to prepare a three-dimensional structure.

The three-dimensional structure was treated with acid by soaking it in a 0.5 M hydrochloric acid (HCl) aqueous solution for 24 hours, washed with distilled water 3 times, and dried at 85° C. for 12 hours.

Thereafter, the three-dimensional structure was fired in a firing furnace in the air atmosphere at 800° C. for 2 hours to prepare a three-dimensional lithium adsorbent.

### Experimental Example 1

The three-dimensional lithium adsorbents according to Examples 1 and 2 were soaked in a 0.5 M lithium chloride (LiCl) aqueous solution, and then the adsorption capacity of the porous foam for adsorbing lithium was calculated from a change in lithium concentration included in the lithium chloride aqueous solution. The adsorption capacity of the three-dimensional lithium adsorbents according to Examples 1 and 2 was 2.5 mg/g.

### Experimental Example 2

A compressive strength at which the three-dimensional lithium adsorbents according to Examples 1 and 2 were compressed at a speed of 0.5 MPa/s and broken was measured. The compressive strength of the three-dimensional lithium adsorbents according to Examples 1 and 2 was 1.5 MPa.

A porous foam for adsorbing lithium adsorption according to the present invention may have a high lithium adsorption rate per unit volume and unit mass.

A method for preparing a porous foam for lithium adsorption according to the present invention may produce a highly durable three-dimensional lithium adsorbent having a high lithium adsorption rate in a shape to be desired.

Hereinabove, although the present specification has been described by specified matters and specific exemplary embodiments, they have been provided only for assisting in the entire understanding of the present invention. Therefore, the present invention is not by the specific matters limited to the exemplary embodiments. Various modifications and changes may be made by those skilled in the art to which the present invention pertains from this description.

Therefore, the spirit described in the present specification should not be limited to the above-described exemplary embodiments, and the following claims as well as all modified equally or equivalently to the claims are intended to fall within the scope and spirit of the specification.

1. A method for preparing a three-dimensional lithium adsorbent, the method comprising:
(S1) coating a surface of a lithium positive electrode active material with one or more silane compounds satisfying the following Chemical Formula 1;
(S2) mixing the lithium positive electrode active material, an inorganic binder, and a polymer bead to prepare a mixture;
(S3) molding the mixture into a three-dimensional structure; and
(S4) firing the three-dimensional structure to prepare the three-dimensional lithium adsorbent:
RₐSi(OR)_{b} (Chemical Formula 1)
wherein R is an alkyl group independently selected from alkyl groups having 1 to 4 carbon atoms; a is 0, 1, or 2; and b is an integer selected from 2 to 4.

2. The method for preparing a three-dimensional lithium adsorbent of claim 1, wherein the lithium positive electrode active material is an oxide including lithium (Li), and one or more metals selected from nickel (Ni), cobalt (Co), manganese (Mn), iron (Fe), magnesium (Mg), titanium (Ti), aluminum (Al), and a combination thereof.

3. The method for preparing a three-dimensional lithium adsorbent of claim 1, wherein the inorganic binder is one or more inorganic binders selected from red clay, cement, and a combination thereof.

4. The method for preparing a three-dimensional lithium adsorbent of claim 1, wherein the mixture of (S2) further includes a polymer binder.

5. The method for preparing a three-dimensional lithium adsorbent of claim 4, wherein the polymer binder is a water-based polymer binder.

6. The method for preparing a three-dimensional lithium adsorbent of claim 1, wherein the polymer bead is thermally decomposed and removed by the firing of (S4).

7. The method for preparing a three-dimensional lithium adsorbent of claim 1, wherein the mixture of (S2) includes 5 to 50 parts by weight of the inorganic binder with respect to 100 parts by weight of the lithium positive electrode active material.

8. The method for preparing a three-dimensional lithium adsorbent of claim 4, wherein the mixture of (S2) includes 5 to 50 parts by weight of the inorganic binder and 1 to 30 parts by weight of the polymer binder with respect to 100 parts by weight of the lithium positive electrode active material.

9. The method for preparing a three-dimensional lithium adsorbent of claim 1, wherein the molding of (S3) is carried out using a three-dimensional stage.

10. A three-dimensional lithium adsorbent prepared by the method of claim 1.
